(19) United States
(12) Patent Application Publication
(10) Pub. No.: US 2019/0103782 A1
(43) Pub. Date: Apr. 4, 2019

(54) STATOR AND MOTOR

(71) Applicant: NIDEC SERVO CORPORATION, Kiryu-shi (JP)

(72) Inventor: Norihisa IMAIZUMI, Kiryu-shi (JP)

(21) Appl. No.: 16/142,074

(22) Filed: Sep. 26, 2018

(30) Foreign Application Priority Data
Sep. 29, 2017 (JP) 2017-191323

(51) Int. Cl. H02K 3/52; H02K 1/14; H02K 3/18; H02K 15/02; H02K 15/06

(52) U.S. Cl. CPC H02K 3/525; H02K 1/145; H02K 15/065; H02K 15/022; H02K 3/18

(57) ABSTRACT

A stator includes a core back that has an annular shape and that extends in a circumferential direction about a central axis that extends in a vertical direction, teeth that extend in a radial direction from the core back, bobbins attachable in the radial direction to the teeth, and coil wires wound around the bobbins. The bobbins each include a cylindrical portion that extends in the radial direction and a protrusion that protrudes in the radial direction from an upper end portion of the cylindrical portion on a core back side and that is fixed to the core back.

### CROSS REFERENCE TO RELATED APPLICATIONS

This application claims the benefit of priority to Japanese Patent Application No. 2017-191323 filed on Sep. 29, 2017. The entire contents of this application are hereby incorporated herein by reference.

### BACKGROUND OF THE INVENTION

### 1. Field of the Invention

The present disclosure relates to a stator and a motor.

### 2. Description of the Related Art

To date, a stator having bobbins that are detachable from a stator core for improving the space factor of coils is known.

In the existing stator, in order to prevent the bobbins from coming off the stator core, an inner stator core is covered with an outer stator core that has a cylindrical shape. In this configuration, the number of elements increases with the inclusion of the outer stator core, and a process of press-fitting the inner stator core is also required, which complicates the manufacturing process.

### SUMMARY OF THE INVENTION

According to one aspect of a preferred embodiment of the present disclosure, a stator includes a core back that has an annular shape and that extends in a circumferential direction about a central axis that extends in a vertical direction, a plurality of teeth that extend in a radial direction from the core back, a plurality of bobbins attachable in the radial direction to the teeth, and coils defined by coil wires wound around the bobbins. The bobbins each include a cylindrical portion that has a cylindrical shape and that extends in the radial direction and a protrusion that protrudes in the radial direction from an upper end portion of the cylindrical portion on a core back side and that is fixed to the core back.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a motor according to a preferred embodiment of the present invention as viewed from above.

FIG. 2 is a cross-sectional view illustrating a motor according to a preferred embodiment of the present invention.

FIG. 3 is a perspective view of a stator according to a preferred embodiment of the present invention.

FIG. 4 is a perspective view showing a mounting structure for bobbins.

FIG. 5 is a cross-sectional view of a stator according to a preferred embodiment of the present invention.

FIG. 6 is a cross-sectional view of a stator of a modification example of a preferred embodiment of the present invention.

### DETAILED DESCRIPTION OF THE PREFERRED EMBODIMENTS

Preferred embodiments of the present disclosure will be described below with reference to the drawings.

In addition, in the present application, the direction parallel to a rotation axis J of a shaft 21 of a motor 11 is referred to as “the axial direction”, the direction perpendicular to the rotation axis J is referred to as “the radial direction”, and the direction along an arc with the rotation axis J as the center is referred to as “the circumferential direction”. In addition, in the present application, the shape and positional relationship of each element will be described with the axial direction taken as the vertical direction and with one side in the axial direction, which is a stator 30 side with respect to a base portion 40, being defined as the upper side. That is, one direction in which the rotation axis J extends is defined as the vertical direction. However, in practicality, there is no intention to limit the orientation of the motor according to the present disclosure to this vertical definition.

In addition, in the present application, the “parallel direction” also includes a substantially parallel direction. In addition, in the present application, the “perpendicular direction” also includes a direction that is substantially perpendicular.

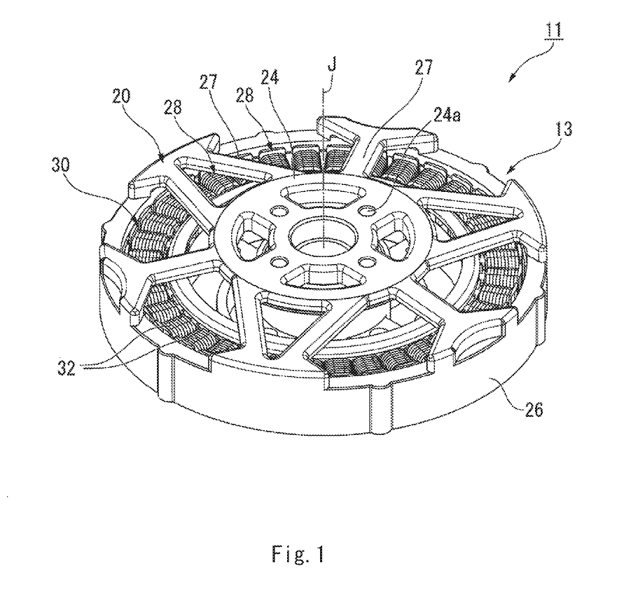

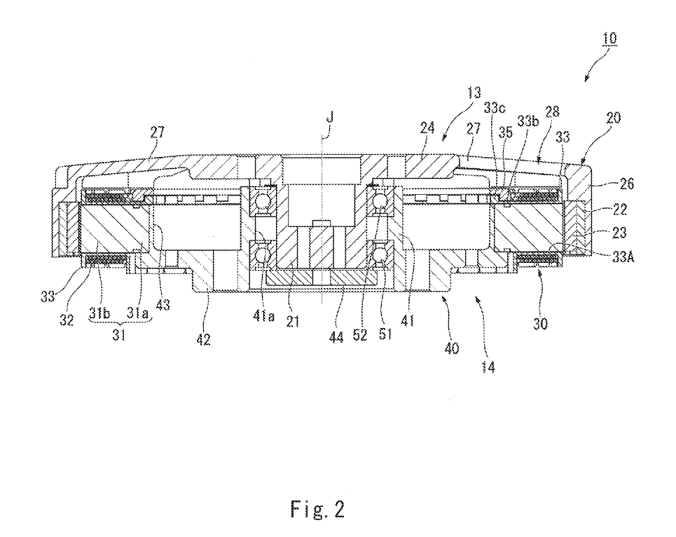

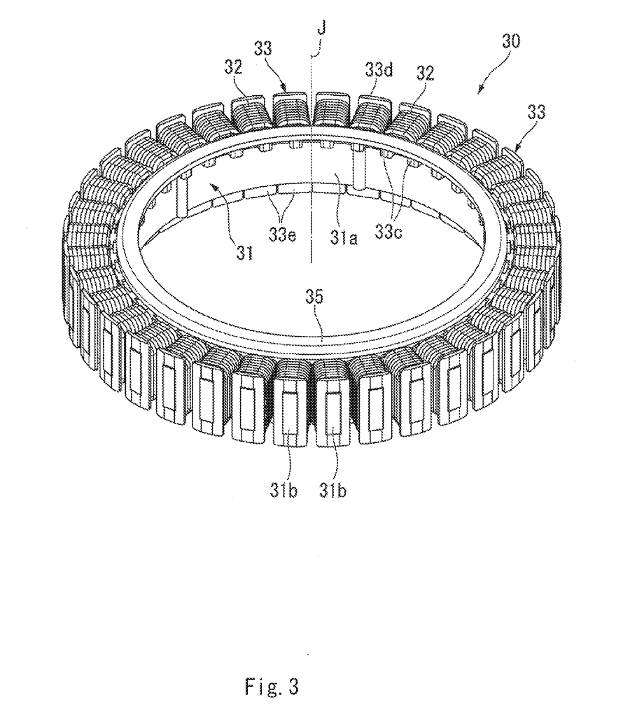

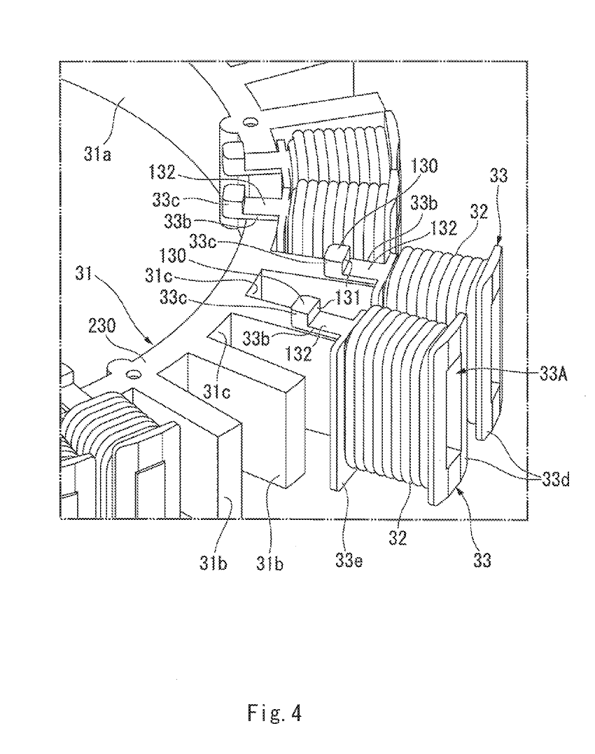

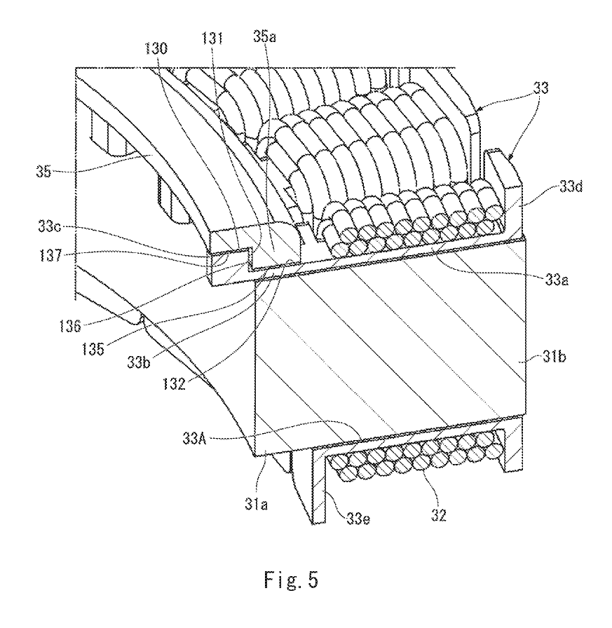

FIG. 1 is a perspective view of the motor according to the present embodiment as viewed from above. FIG. 2 is a cross-sectional view illustrating the motor according to the present embodiment. FIG. 3 is a perspective view of a stator. FIG. 4 is a perspective view showing a mounting structure for bobbins. FIG. 5 is a cross-sectional view of the stator.

The motor 11 of the present embodiment is used as, for example, a motor that rotates rotor blades in a multi-copter. Hereinafter, the motor 11 of the present embodiment that is to be mounted in a multi-copter will be described; however, the application of the motor 11 is not limited to a multi-copter.

As illustrated in FIG. 1 and FIG. 2, the motor 11 of the present embodiment is an outer rotor type motor. The motor 11 includes a rotor 13 to which rotor blades are fixed and a stationary portion 14 that is to be attached to a multi-copter. As illustrated in FIG. 2, the rotor 13 and the stationary portion 14 are connected via bearing portions 51 and 52 that support the rotor 13 so as to be rotatable. The rotor 13 is an element that rotates in the circumferential direction with the rotation axis J as the center thereof.

The rotor 13 has the shaft 21, a rotor main body 20, magnets 23, and a yoke 22. The shaft 21 extends in the axial direction with the rotation axis J as the center thereof. The shaft 21 is supported by the bearing portions 51 and 52 so as to be rotatable. The bearing portions 51 and 52 are ball bearings each formed of an inner ring, an outer ring, balls, and a retainer. Further, the bearing portions 51 and 52 may be sliding bearings. The shaft 21 is inserted into a base through hole 41a of the base portion 40 (described later) and inserted into the inner rings of the bearing portions 51 and 52.

The rotor main body 20 is connected to the upper end of the shaft 21. The rotor main body 20 extends from the upper end of the shaft 21 along the upper surface of the stator 30 to the outer peripheral surface of the stator 30. The rotor main body 20 includes a rotor disc portion 24 extending from the upper end of the shaft 21 in a direction perpendicular to the rotation axis J, a plurality of rotor rib portions 27 extending outward in the radial direction from the outer peripheral end of the rotor disc portion 24, and a rotor outer edge portion 26 that has a substantially cylindrical shape extending downward from the outer end of the rotor rib portions 27. In the case of the present embodiment, the shaft 21 and the rotor main body 20 are a single member.

The rotor disc portion 24 has a plurality of rotor member fixing portions 24a to which the rotor blades are fixed. In the present embodiment, the rotor member fixing portions 24a are through holes that penetrate the rotor disc portion 24 in the axial direction. Internal threads are provided on the inner peripheral surfaces of the rotor member fixing portions 24a. The rotor blades are fixed to the rotor main body 20 by screws tightened to the rotor member fixing portions 24a. The rotor blades may be fixed to the rotor main body 20 by a method other than screws, such as bonding or caulking.

The rotor rib portions 27 extend outward in the radial direction from the outer peripheral end of the rotor disc portion 24. The rotor rib portions 27 connect the rotor disc portion 24 and the rotor outer edge portion 26 to each other. As illustrated in FIG. 1, the rotor rib portions 27 are bar-like portions extending in the radial direction. The rotor rib portions 27 extend to the upper end surface of the rotor outer edge portion 26. The plurality of rotor rib portions 27 are, for example, arranged at unequal intervals along the circumferential direction. For example, six rotor rib portions 27 are provided.

As a result of connecting the rotor disc portion 24 and the rotor outer edge portion 26 with the plurality of the rotor rib portions 27, the rotor main body 20 has rotor hole portions 28 between the rotor rib portions 27 in the circumferential direction. The rotor hole portions 28 are holes penetrating the rotor main body 20 in the axial direction. For example, six rotor hole portions 28 are provided.

Because the rotor main body 20 has the rotor hole portions 28, air circulation paths to the inside of the motor 11, that is, the stator 30, are formed, and the stator 30 can be cooled when the motor 11 is driven. In the present embodiment, the rotor hole portions 28 open above the stator 30 and the outside air directly impinges against coils 32. As a result, the heated coil wire can be efficiently cooled.

The yoke 22 is a substantially cylindrical member with the rotation axis J as the center thereof. The yoke 22 is disposed on the inner peripheral surface of the rotor outer edge portion 26. The yoke 22 is composed of a ferromagnetic material. The yoke 22 covers at least a portion of the outer peripheral surface of the magnets 23. As a result, leakage of magnetic force from the outer peripheral surface of the magnets 23 is suppressed.

The magnets 23 have a rectangular plate shape that is elongated in the axial direction. In this embodiment, a plurality of the magnets 23 are provided. In the present embodiment, 42 magnets 23 are provided. The magnets 23 are fixed to the inner peripheral surface of the yoke 22 by, for example, an adhesive. The magnets 23 have magnetic N poles and S poles on the inner peripheral surface thereof. The magnets 23 having the magnetic N poles and the magnets 23 having the magnetic S poles are arranged alternately along the circumferential direction.

As illustrated in FIG. 2, the inner circumferential surface of the magnets 23 opposes an outer end surface of a plurality of teeth 31b (to be described later) in the radial direction with a slight gap therebetween. That is, the magnets 23 have magnetic pole surfaces that oppose the stator 30 in the radial direction. Further, a magnet having a substantially cylindrical shape surrounding the entire outer peripheral surface of the stator 30 may be used. In this case, N poles and S poles are alternately magnetized in the circumferential direction on the inner peripheral surface of the magnet.

The stationary portion 14 includes the base portion 40 and the stator 30. As illustrated in FIG. 2, the base portion 40 includes a base cylindrical portion 41 extending in the axial direction with the rotation axis J as the center thereof, a base bottom portion 42 extending outward from the lower end portion of the base cylindrical portion 41 in the radial direction, and a stator-supporting cylindrical portion 43, which is cylindrical, extending upward in the axial direction from an outer end portion of the base bottom portion 42 in the radial direction.

A stator core 31 (to be described later) of the stator is fixed to the outer peripheral surface of the stator-supporting cylindrical portion 43.

The base cylindrical portion 41 has the base through hole 41a penetrating the base cylindrical portion 41 in the axial direction with the rotation axis J as the center thereof. The bearing portions 51 and 52 are arranged inside the base through hole 41a.

The two bearing portions 51 and 52 are arranged side by side in the axial direction inside the base through hole 41a. A lid portion 44 presses the bearing portion 51 from the lower side. The bearing portions 51 and 52 are fixed to the shaft 21 and the base portion 40 thereby supporting the rotor 13 so as to be rotatable with the rotation axis J as the center thereof.

As illustrated in FIG. 2, the stator 30 opposes the rotor 13 in the radial direction with a gap therebetween. As illustrated in FIG. 3, the stator 30 is an armature having the stator core 31 and a plurality of the coils 32 to which an electric current is supplied. That is, the stationary portion 14 has a plurality of the coils 32.

The stator core 31 is a magnetic body. The stator core 31 of the present embodiment is formed of a laminated steel plate formed by laminating electromagnetic steel plates in the axial direction. The stator core 31 is fixed to the base portion 40. As illustrated in FIG. 3 and FIG. 4, the stator core 31 has a core back 31a and the plurality of the teeth 31b. The core back 31a has an annular shape with the rotation axis J as the center thereof. The plurality of the teeth 31b extend outward in the radial direction from the core back 31a. The plurality of the teeth 31b are arranged at substantially equal intervals in the circumferential direction. The teeth 31b have a rectangular parallelepiped shape having no umbrella portion at an outer peripheral end thereof.

The coils 32 are structures composed of coil wires wound around bobbins 33. The bobbins 33 are rectangular cylindrical members extending in the radial direction and each have a through hole 33A into which a corresponding one of the teeth 31b is inserted. The bobbins 33 are composed of an insulating material such as resin. In the stator 30 of the present embodiment, because the teeth 31b do not have an umbrella portion, the bobbins 33 can be attached to and detached from the teeth 31b of the stator core 31 from the outer side in the radial direction. According to this configuration, because each of the coil wires can be wound around the bobbins 33 in a state where the bobbins 33 are detached from the teeth 31b, the coil wire can be wound around the bobbins 33 at a high density. When the number of slots is large like the stator 30 of the present embodiment, manufacture is facilitated.

As illustrated in FIG. 4 and FIG. 5, each of the bobbins 33 includes a cylindrical portion 33a that has a cylindrical shape and that extends in the radial direction, a protruding piece 33b that protrudes inward in the radial direction from the upper end portion of the cylindrical portion 33a on the core back 31a side, a flange portion 33d that extends in a direction perpendicular to the radial direction from the outer end portion of the cylindrical portion 33a in the radial direction and a flange portion 33e that extends in a direction perpendicular to the radial direction from an inner end portion of the cylindrical portion 33a in the radial direction.

As illustrated in FIG. 4, the protruding piece 33b is in the shape of a thin plate, and has a claw portion 33c that protrudes upward from the protruding piece 33b on the upper surface of the inner end portion in the radial direction. The claw portion 33c has an upper surface 130 and a surface 131 that extends upward from the upper surface of the protruding piece 33b and that faces outward in the radial direction. The protruding piece 33b is positioned on an upper surface 230 of the core back 31a when the bobbin 33 is attached to the corresponding one of the teeth 31b. The tip end portion where the claw portion 33c of the protruding piece 33b is provided protrudes inward from the upper surface 230 of the core back 31a in the radial direction. That is, an upper surface 132 of the protruding piece 33b has a length equal to that of the core back 31a in the radial direction.

As illustrated in FIG. 3 and FIG. 5, the stator 30 has a fixing member 35 that has an annular shape and that covers the protruding pieces 33b on the core back 31a from the upper side. The fixing member 35 is a stepped ring having an annular protruding portion 35a arranged along the outer peripheral side of the lower surface of the fixing member 35 and protruding downward. The fixing member 35 is disposed on the core back 31a in a posture in which the annular protruding portion 35a is positioned on the upper surface 132 of the protruding piece 33b.

The fixing member 35 makes contact with the upper surface 132 of the protruding piece 33b at a lower surface portion 135 of the annular protruding portion 35a. In addition, the fixing member comes into contact with the upper surface 130 of the claw portion 33c at a lower surface 137 positioned inward of the annular protruding portion 35a. A peripheral surface portion 136 of the annular protruding portion 35a facing inward in the radial direction faces in the radial direction the surface 131 of the claw portion 33c facing outward in the radial direction.

Because the fixing member 35 and the protruding pieces 33b of the bobbins 33 are arranged as described above, the bobbins are prevented from moving outward in the radial direction. Specifically, because the claw portions 33c are caught by the annular protruding portion 35a of the fixing member 35, the bobbins 33 are prevented from moving outward in the radial direction. That is, in the stator 30 of the present embodiment, the protruding pieces 33b of the bobbins 33 are fixed to the core back 31a by the fixing member 35. As a result, the movement of the bobbins 33 detachably attachable to the teeth 31b is suppressed. According to this configuration, it is not necessary to provide on the outer periphery of the stator 30 a cylindrical member that prevents the bobbins 33 from coming off, which facilitates manufacturing.

In addition, in the present embodiment, because the movement of the bobbins 33 in the radial direction is suppressed using the claw portions 33c provided on the protruding pieces 33b, the bobbins 33 do not have a complicated structure and can be easily manufactured.

In addition, because all the bobbins 33 are fixed all at once by the fixing member 35 that has an annular shape, the number of elements can be reduced and the assembly work of the stator 30 can be made efficient.

In the present embodiment, the fixing member 35 is adhered to the core back 31a and the protruding pieces 33b. Specifically, the fixing member 35 and the protruding pieces 33b are adhered to each other at the lower surface portion 135 of the annular protruding portion 35a and the upper surface 132 of the protruding pieces 33b. The fixing member 35 and the core back 31a are adhered to each other at the lower surface portion 135 of the annular protruding portion 35a and the upper surface 230 of the core back 31a that is exposed between circumferentially adjacent ones of the protruding pieces 33b. By adhering the fixing member 35, the core back 31a and the protruding pieces 33b to one another, the bobbins 33 are more firmly fixed to the stator core 31.

The protruding pieces 33b may be adhered to the upper surface 230 of the core back 31a. In this case, the protruding pieces 33b and the core back 31a may be adhered to each other with an adhesive applied to a side surface of the protruding pieces 33b that faces in the circumferential direction. In addition, the protruding pieces 33b and the core back 31a may be adhered to each other with an adhesive disposed between the lower surface of the protruding pieces 33b and the upper surface 230 of the core back 31a. With this configuration, the bobbins 33 can be more firmly fixed to the stator core 31.

The bobbins 33 may be adhered to an outer peripheral surface 31c of the core back 31a that is exposed between the teeth 31b. In the case of the present embodiment, the flange portions 33e of the bobbins 33 and the outer peripheral surface 31c of the core back 31a may be adhered to each other with an adhesive. According to this configuration, because the bobbins 33 are adhered and fixed in the vertical direction, the bobbins 33 can be further firmly fixed to the stator core 31.

In the present embodiment, the protruding pieces 33b are provided only at the upper end portion of the bobbins 33; however, the protruding pieces 33b may be provided at the upper end portion and the lower end portion of the bobbins 33, and the fixing member 35 may also be arranged on the upper and lower surfaces of the stator core 31. According to this configuration, because the bobbins 33 are fixed above and below the stator 30, the bobbins 33 can be more firmly fixed.

In the motor 11 such as that described above, when a driving current is supplied to the coils 32, a magnetic flux is generated in the plurality of the teeth 31b. Then, due to the action of the magnetic flux between the teeth 31b and the magnets 23, circumferential torque is generated between the stator 30 and the rotor 13. As a result, the rotor 13 rotates around the rotation axis J with respect to the stator 30. The rotor blades supported by the rotor 13 rotate together with the rotor 13 around the rotation axis J.

The present disclosure is not limited to the above-described embodiments, and other configurations may be adopted.

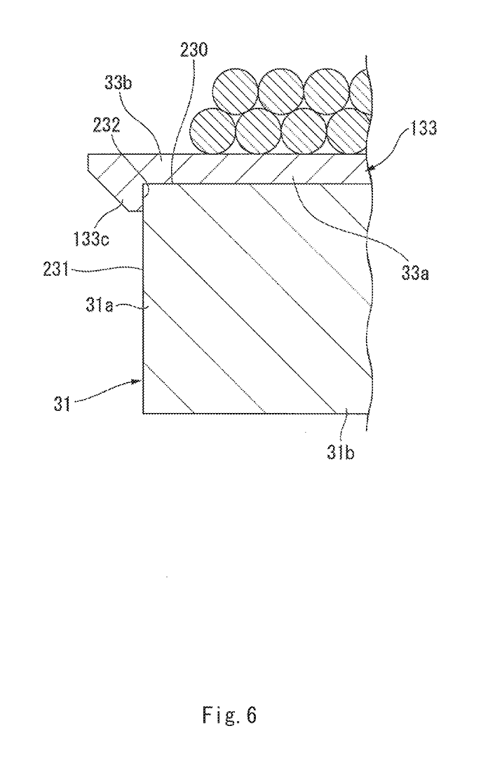

FIG. 6 is a cross-sectional view of a stator of a modification example.

A bobbin 133 illustrated in FIG. 6 is different from the bobbin 33 of the above embodiment in terms of the configuration of the claw portion. Specifically, the bobbin 133 has a claw portion 133c that protrudes downward from the lower surface of the protruding piece 33b. The claw portion 133c is located inward of the upper surface 230 of the core back 31a in the radial direction and is hooked at a corner portion between the upper surface 230 of the core back 31a and an inner peripheral surface 231. That is, the claw portion 133c is hooked on an end portion in the radial direction opposite to the teeth 31b of the core back 31a.

According to the configuration of the modification example, the bobbin 133 can be fixed to the core back 31a by snap-fitting. As a result, because the bobbin 133 can be fixed to the stator core 31 without using the fixing member 35, the number of elements can be reduced and the assembly operation can be made efficient.

In the above modification example, the protruding pieces 33b and the core back 31a may be adhered to each other. In this case, the lower surfaces of the protruding pieces 33b and the upper surface 230 of the core back 31a may be adhered to each other with an adhesive. In addition, surfaces 232 of the claw portions 133c facing the outer side in the radial direction and the inner peripheral surface 231 of the core back 31a may be adhered to each other with an adhesive.

In addition, in the modification example, the protruding pieces 33b may be provided at the upper end portion and the lower end portion of the bobbins 133. According to this configuration, because the bobbins 133 are fixed above and below the stator 30, the bobbins 133 can be more firmly fixed.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator comprising:
a core back that has an annular shape and that extends in a circumferential direction about a central axis that extends in a vertical direction;
a plurality of teeth that extend in a radial direction from the core back;
a plurality of bobbins attachable in the radial direction to the teeth; and
coils defined by coil wires wound around the bobbins;
wherein
the bobbins each include a cylindrical portion that has a cylindrical shape and that extends in the radial direction and a protrusion protruding in the radial direction from an upper end of the cylindrical portion on a core back side and fixed to the core back.

2. The stator according to claim 1, wherein the protrusion includes a claw portion protruding upward or downward at a tip end portion thereof.

3. The stator according to claim 2, wherein
the claw portion protrudes upward from the protrusion;
the stator includes a fixing member that has an annular shape and that covers the core back and the protrusion from an upper side.

4. The stator according to claim 3, wherein the fixing member includes a lower surface portion that is in contact with an upper surface of the protrusion positioned between the cylindrical portion and the claw portion and a peripheral surface portion that extends upward from an end portion of the lower surface portion on a claw portion side and that faces a surface of the claw portion that faces the cylindrical portion side.

5. The stator according to claim 3, wherein the fixing member is adhered to the core back and the protrusion.

6. The stator according to claim 2, wherein the claw portion protrudes downward from the protrusion and is hooked to an end portion of the core back in the radial direction that is on a side opposite to the teeth.

7. The stator according to claim 1, wherein the protrusion is adhered to an upper surface of the core back.

8. The stator according to claim 1, wherein the bobbins are adhered to a surface of the core back that is exposed between the teeth.

9. The stator according to claim 1, wherein the teeth extend outward of the core back in the radial direction.

10. A motor comprising:
the stator according to claim 1.
